(19) United States
(12) Patent Application Publication
(10) Pub. No.: US 2026/0169441 A1
(43) Pub. Date: Jun. 18, 2026

(54) CHRONOGRAPH MECHANISM AND METHOD FOR ASSEMBLING A CHRONOGRAPH MECHANISM

(71) Applicant: ETA SA MANUFACTURE HORLOGÈRE SUISSE, Grenchen (CH)

(72) Inventor: Stéphane BACHMANN, Büren an der Aare (CH)

(73) Assignee: ETA SA MANUFACTURE HORLOGÈRE SUISSE, Grenchen (CH)

(21) Appl. No.: 19/373,952

(22) Filed: Oct. 30, 2025

(30) Foreign Application Priority Data
Dec. 17, 2024 (EP) 24220734.8

(51) Int. Cl. G04F 7/08

(52) U.S. Cl. CPC G04F 7/0814

(57) ABSTRACT

A chronograph mechanism (10) for a horology movement (1) including a zero reset mechanism (100) including: a first hammer (110) and a second hammer (120) configured on two levels to respectively engage with non-coplanar zero reset organs (51, 52); the first hammer (110) and the second hammer (120) being rotationally coupled by a resilient coupling organ (116) arranged between the first hammer (110) and the second hammer (120).

### CROSS-REFERENCE TO RELATED APPLICATIONS

This application claims priority to European Patent Application No. 24220734.8, filed on December 17, 2024, the entire contents of which are incorporated herein by reference.

### TECHNICAL FIELD OF THE INVENTION

The present invention relates to a chronograph mechanism for horology movements.

More specifically, the invention relates to a chronograph mechanism comprising a mechanism for zero resetting the chronograph counters.

The invention also relates to a method for assembling a chronograph mechanism.

### Technological background

Chronograph mechanisms enable time to be measured on demand using multiple chronograph counters, for example minutes and seconds.

Chronograph mechanisms typically comprise a zero reset mechanism for resetting the chronograph counters, thereby returning them to a reference position so that time can be again measured on demand.

Conventionally, such a zero reset mechanism consists of a zero reset control that can be operated by the user, for example via a button or an actuating blom stud accessible from outside the middle in which the horology movement is mounted.

The zero reset control engages directly or indirectly via levers with zero reset hammers that strike the zero reset cams carried by the various chronograph counters.

The chronograph counters and corresponding hands are reset to zero when the hammers bear on the reset cams, generating a drive couple that changes the position of the chronograph counters until they return to a reference position determined by the geometry of the hammers and of the reset cam.

In the existing chronograph mechanisms, the hammers are either made in one piece or consist of separate parts secured to each other by securing means. In this case, they have a common actuating control. An exemplary embodiment is described in particular in application EP 2241945.

Setting zero reset mechanisms is complicated, time-consuming and requires skilled workmanship. Indeed, to set such a mechanism, the seconds hammer has to be brought into contact with the seconds zero reset cam in its reference position. Then, the pane on the minute hammer has to be filed down so that the minute zero reset cam is also in the reference position. This operation is long and intricate and can only be carried out by a specialised horologist.

One solution to this tedious setting operation is to use two overlapping hammers that are conjugate in their angular movement while allowing limited relative angular movement of one hammer with respect to the other during the zero reset. Such a solution is described in particular in patent CH 220536. In particular, this approach allows both hammers to act simultaneously on their respective heart pieces and helps keep the chronograph hands from shifting in the reference position.

However, with such a solution, the overlapping hammers come into contact with the zero reset cams with little energy because a large part of the actuating energy is absorbed by the return and damper spring, which exerts an increasing stress against the movements of the hammers. There is thus a risk that the chronograph counters will not be correctly set to zero with such a mechanism.

There is thus a need for improved chronograph mechanisms and in particular for zero reset mechanisms for counters on such chronograph mechanisms.

### SUMMARY OF THE INVENTION

To this end, the invention aims to provide a chronograph mechanism that offers a solution to at least one of the aforementioned problems.

One of the objectives of the invention is to provide a zero reset mechanism that provides precise zero resetting of the various chronograph counters.

One of the objectives of the invention is to provide a reliable and secure zero reset mechanism.

To this end, the invention relates to a chronograph mechanism for horology movements comprising a zero reset mechanism comprising:

a first hammer and a second hammer configured on two levels to respectively engage with a first zero reset organ on a first chronograph counter and a second zero reset organ on a second chronograph counter that are not coplanar; the first hammer and the second hammer pivoting separately relative to each other around at least one axis of rotation;

a resilient coupling organ, arranged between the first hammer and the second hammer, which has an operating position in which a first bracket bears on the first hammer and a second bracket bears on the second hammer.

The zero reset mechanism further comprises a preliminary support organ on the resilient coupling organ arranged on the second hammer and configured to support said first bracket on the resilient coupling organ in a pre-assembly position, and a clip-on organ, secured to the first hammer, configured to engage with the first bracket on the resilient coupling organ and move said resilient coupling organ into its operating position in which the first bracket bears on the clip-on organ to ensure rotationally elastic coupling of the first hammer and of the second hammer, during a relative axial displacement between the first hammer and the second hammer in a direction parallel to the axis of rotation of the hammers, when assembling the hammers.

In addition to the characteristics mentioned in the previous paragraph, the chronograph mechanism according to the invention can have one or more complementary characteristics from among the following, taken individually or in any technically possible combination:

the resilient coupling organ ensures rotational coupling between the first hammer and the second hammer in the absence of a stress greater than a value predetermined by the stiffness of the resilient coupling organ applied to one of the hammers;

the clip-on organ is configured to ensure deflection of the resilient coupling organ when assembling the two hammers, such that the resilient coupling organ in the operating position has a second compressed state that is more compressed than a first compressed state of the resilient coupling organ in the pre-assembly position on the second hammer;

the clip-on organ extends in a direction parallel to said at least one axis of rotation of the hammers;

the clip-on organ comprises a body, with a portion forming a first support organ supporting the first bracket on the resilient coupling organ in the operating position of the resilient coupling organ, and an end cone forming the free end of the clip-on organ;

the first support organ on the first hammer has a recessed portion to axially secure the first bracket on the resilient coupling organ, in an axial direction parallel to the at least one axis of rotation of the hammers;

said recessed portion is formed near the base of the end cone;

the second hammer comprises a second support organ configured to support the second bracket on the resilient coupling organ, the second support organ having a recessed portion for axially securing the second bracket on the resilient coupling organ in an axial direction parallel to the at least one axis of rotation of the hammers;

the chronograph mechanism comprises a zero reset control that can be actuated by the user and is configured to rotate the first hammer;

the resilient coupling organ is shaped to elastically restrain the second hammer bearing on a stop surface on the first hammer;

the second hammer comprises a stop organ against which the support surface on the first hammer bears;

the first hammer and the second hammer have a shared axis of rotation or have dedicated axes of rotation that are parallel to each other.

The invention also relates to a horology movement comprising a chronograph mechanism according to the invention.

The invention also relates to a timepiece comprising a horology movement according to the invention.

The invention also relates to a method for assembling a chronograph mechanism and, more specifically, to all of the hammers on the zero reset mechanism.

More specifically, the assembly method comprises a step in which the resilient coupling organ is positioned on the second hammer, the resilient coupling organ being kept in a pre-assembly position in a first compressed state between a preliminary support organ carried by the second hammer and a second support organ on the second hammer, and a step in which the first hammer and the second hammer are assembled by relative axial displacement of the two hammers in a direction parallel to the at least one axis of rotation, the relative axial displacement between the two hammers ensuring the elastic coupling between the two hammers by elastically distorting the resilient coupling organ.

Preferentially, the elastic coupling between the two hammers in the assembly step is achieved by means of a clip-on organ secured to the first hammer and configured to engage with the resilient coupling organ in the pre-assembly position and to move said resilient coupling organ into an operating position, in a second compressed state, in which the resilient coupling organ is compressed between the clip-on organ and the second support organ on the second hammer.

### BRIEF DESCRIPTION OF THE FIGURES

The purposes, advantages and characteristics of the present invention will become apparent from the detailed description below in reference to the following figures:

FIG. 1 is a partial schematic view of an exemplary embodiment of a chronograph mechanism for a horology movement comprising a mechanism for zero resetting the chronograph counters according to the invention;

FIG. 2 is an exploded view more specifically illustrating the dual hammer system of the zero reset mechanism shown in FIG. 1, elastically coupled by a resilient coupling organ;

FIG. 3 more specifically illustrates the resilient coupling organ pre-assembled on the second hammer before assembling and rotationally coupling the two hammers;

FIG. 4 more specifically illustrates the resilient coupling organ in the operating position in which it bears on the first hammer and the second hammer in order to rotationally couple the two hammers;

FIG. 5 schematically illustrates the main steps in a method for assembling a chronograph mechanism according to the invention.

In all of the figures, common elements have the same reference numbers unless otherwise specified.

### DETAILED DESCRIPTION OF THE INVENTION

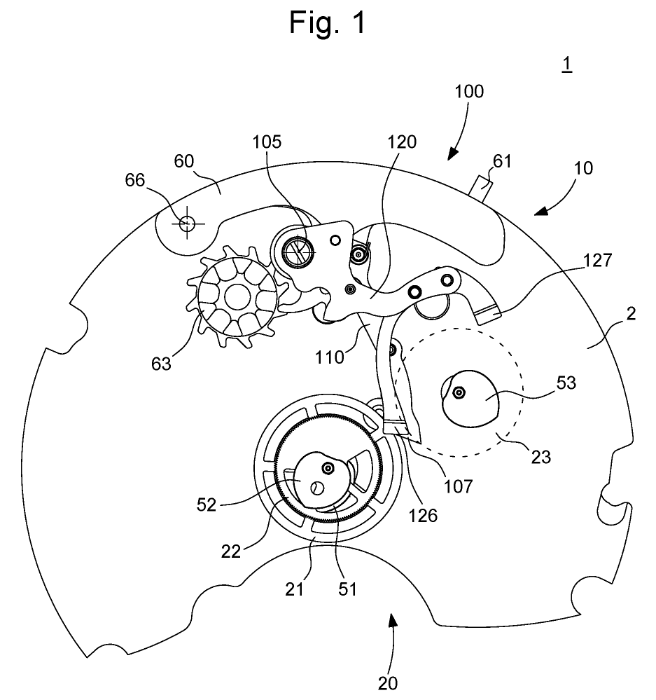

FIG. 1 is a partial schematic top view of a chronograph mechanism 10 embedded in a horology movement 1 according to the invention.

Referring to FIG. 1, the horology movement 1 comprises a plate 2 acting as a support for the various elements of the horology movement 1, in particular a time train (not shown) for time graduation, that is driven by an energy source (not shown).

The chronograph mechanism 10 comprises a chronograph train 20 that can be kinematically joined, on demand, to the hour train via a coupling (not shown) controlled by a chronograph start/stop control.

For example, the coupling is a lever coupling that enables a coupling wheel to pivot. Other variant couplings known to those skilled in the art could also apply.

In particular, the chronograph train 20 comprises a first chronograph counter comprising a first chronograph counter wheel 21, for example a seconds counter wheel, and a second chronograph counter comprising a second chronograph counter wheel 22, for example a minute counter wheel.

The first seconds counter wheel 21 is coupled to a first arbor, called the seconds counter arbor, driving a seconds hand on a chronograph (not shown). The first arbor also carries a first zero reset organ 51 that is rotationally secured to the arbor.

The second minute counter wheel 22 is coupled to a second arbor, known as the minute counter arbor, which drives a chronograph minute hand (not shown). The second arbor also carries a second zero reset organ 52 that is rotationally secured to the arbor.

The first arbor and the second arbor are coaxial.

The first wheel on the seconds counter 21 and the second wheel on the minutes counter 22 overlap and are arranged in two separate planes, overlapping and parallel. The respective zero reset organs 51, 52 also overlap each other.

The zero reset organs 51, 52 are, for example, snail-shaped, heart-shaped or other zero reset cams, where the shape enables them to be returned to a reference position of the hands when actuated by zero reset hammers.

In the example shown, the zero reset organs 51, 52 are zero reset heart pieces.

As shown in FIG. 1, the chronograph train 20 can also comprise a third additional counter, for example an hour counter, comprising a third chronograph counter wheel 23 connected to a third zero reset organ 53.

The chronograph train 20 can comprise intermediate chronograph mobiles (not shown) to obtain the desired ratios between the various counter wheels 21, 22, 23 on the chronograph mechanism 10.

The chronograph mechanism 10 also comprises a zero reset mechanism 100 for resetting the various chronograph counters and returning the zero reset organs 51, 52, 53 and the corresponding hands to their reference positions.

The zero reset mechanism 100 comprises a first hammer 110 and a second hammer 120 overlapping each other and shaped to engage respectively with the first zero reset organ 51 on the first chronograph counter and the second zero reset organ 52 on the second chronograph counter. The hammers 110, 120 are rotated by a zero reset control 60 that can be operated by the user, for example via a button or an actuating blom stud 61.

The zero reset control 60 is rotationally mobile around an axis of rotation 66 and engages directly or indirectly with one of the hammers 110, 120.

In the exemplary embodiment shown, the zero reset control 60 engages directly with the first hammer 110 located in the lower position (that is, the hammer near the plate 2). However, the zero reset control 60 can also engage directly with the second hammer 120, located in the upper position (that is, the distal hammer on the plate 2).

To this end, the first hammer 110 comprises an activation element 113, for example a pin or a prong, securely mounted so as to protrude onto the body of the first hammer 110 and configured to engage in direct contact with a portion of the zero reset control 60.

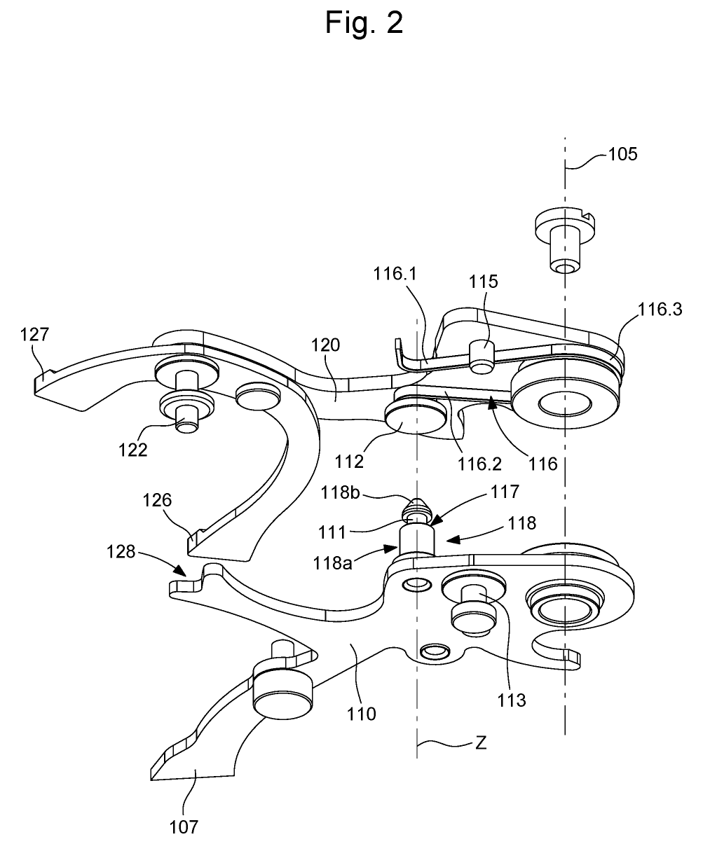

FIG. 2 more specifically illustrates an exploded view of the set of overlapping hammers 110, 120 according to the invention.

The first hammer 110 and the second hammer 120 are pivotally mounted around a shared axis of rotation 105 extending perpendicularly to the overall plane formed by the plate 2. The two hammers 110, 120 are mounted so as to pivot separately relative to each other.

According to a variant embodiment, the first hammer 110 and the

second hammer 120 can have different axes of rotation that are parallel to each other.

The second hammer 120 has limited angular freedom relative to the first hammer 110. To this end, an angular movement limiting device can be arranged between the first hammer 110 and the second hammer 120 to limit the angular travel of the second hammer 120 relative to the first hammer 110 around the axis of rotation 105.

A resilient coupling organ 116 is arranged between the first hammer 110 and the second hammer 120 to create a rotationally elastic coupling between the two hammers 110, 120.

More specifically, the resilient coupling organ 116 enables the first hammer 110 and the second hammer 120 to be rotationally coupled while allowing relative angular freedom of the second hammer 120, by elastic distortion of the resilient coupling organ 116, when a stress greater than a predetermined value, defined by the stiffness of the resilient coupling organ 116, is applied to one of the hammers 110, 120, more specifically the second hammer 120 in the exemplary embodiment illustrated, since in the example shown the zero reset control 60 is engaging with the first hammer 110 to rotate it.

More specifically, the resilient coupling organ 116 comprises a first resilient bracket 116.1 and a second resilient bracket 116.2. The two resilient brackets 116.1, 116.2 are joined on an elbow-shaped central body 116.3. The resilient coupling organ 116 is, for example, a spring, a blade spring, a string spring, etc.

When the resilient coupling organ 116 is in its operating position, as shown more specifically in FIG. 4, the first bracket 116.1 bears on the first hammer 110, and more specifically on a first support organ 111 on the first hammer 110, and the second bracket 116.2 bears on the second hammer 120, and more specifically on a second support organ 112 on the second hammer 120.

The first support organ 111 and/or the second support organ 112 can be elements added and secured to the bodies of the hammers 110, 120, or are made of the same material as the bodies of the hammers 110, 120.

In this operating position, the resilient coupling organ 116 is configured to restrain the second hammer 120 bearing on the first hammer 110 in the absence of a stress applied to the second hammer 120 greater than a value predetermined by the stiffness of the resilient coupling organ 116.

More specifically, the second hammer 120 comprises a stop organ 122, directed towards the first hammer 110 and configured to engage with a complementary stop surface 128 arranged on the first hammer 110. Under the elastic restraint of the resilient coupling organ 116 pressing against the two hammers 110, 120, the stop organ 122 on the second hammer 120 is kept pressed against the stop surface 128 on the first hammer 110.

The first hammer 110 comprises a first pane 107 configured to strike the first zero reset organ 51 on the first counter. The second hammer 120 comprises a second pane 126 configured to strike the second zero reset organ 52 on the second counter.

When in a stable position, meaning when not exerting any stress on the second hammer 120 greater than a predetermined value in relation to the stiffness of the resilient coupling organ 116, the second pane 126 on the second hammer 120 is not aligned with the first pane 107 on the first hammer 110. In fact, the second pane 126 on the second hammer 120 is slightly offset towards the front (that is, in the direction of the zero reset organs 51, 52) relative to the first pane 107 on the first hammer 110.

The forward offset of the second pane 126 on the second hammer 120 ensures that both zero reset organs 51, 52 are returned to their reference position at the end of the movement of the hammers 110, 120 and of the zero reset control 60. Indeed, when the hammers 110, 120 are actuated, once the second zero reset organ 52 on the second counter is in the zero reset

position, a supplementary angular displacement of the hammers 110, 120 will generate a stress on the second pane 126 of the second hammer 120 that is greater than the stiffness of the resilient coupling organ 116, which will allow the first reset organ 51 on its first counter to complete its zero reset if it has not yet reached its reference position. A retrograde movement of the second hammer 120 relative to the first hammer 110 is thus initiated by counteracting the elastic stress of the resilient coupling organ 116.

The chronograph mechanism described below functions as follows:

When the user presses the zero reset control 60 via the actuating blom stud 61, the zero reset control 60 pivots around its axis of rotation 66, which engages the first hammer 110 via the activation element 113 and pivots the first hammer 110 around the axis of rotation 105.

If no stress is applied to the second pane 126 on the second hammer 120, the second hammer 120 is rotationally coupled to the first hammer 110 and is thus also set in motion by the zero reset control 60 and pivots around the axis of rotation 105.

The two hammers 110, 120 continue their angular movement under the action of the zero reset control 60 until the panes 107, 126 strike the respective zero reset organs 51, 52.

Due to the advance of the second pane 126 on the second hammer 120, the second zero reset organ 52 will be reset to the reference position before reaching the full angular travel of the zero reset control 60.

As the zero reset control 60 continues its angular displacement, the second zero reset organ 52 on the second counter, being in the reference position which is a stable position, exerts a stress on the second pane 126 that is greater than the stiffness of the resilient coupling organ 116 and that elastically distorts the resilient coupling organ 116 and changes the relative position of the two hammers 110, 120. This decoupling of the two hammers 110, 120 allows the first hammer 110 to continue its angular movement, driven by the zero reset control 60, to ensure that the first zero reset organ 51 on the first counter is completely reset.

When the zero reset control 60 reaches the end of its travel, the two panes 116 and 126 are aligned relative to each other and the two zero reset organs 51, 52 are positioned in their reference position.

The second hammer 120 further comprises a third pane 127 configured to reset the third zero reset organ 53 to its reference position.

Advantageously, the zero reset mechanism 100 comprises a preliminary support organ 115 to ensure preliminary support of the resilient coupling organ 116 in position and to facilitate the assembly of the two hammers 110, 120 in the horology movement 1. The preliminary support organ 115 also makes it easier to mount the resilient coupling organ 116 between the two hammers 110, 120.

In the example shown in the figures, the preliminary support organ 115 is arranged on the second hammer 120 such that the resilient coupling organ 116 can be pre-mounted on the second hammer 120 before the two hammers 110, 120 are assembled.

Of course, the preliminary support organ 115 can also be arranged on the first hammer 110, which is the hammer activated by the zero reset control 60, such that the resilient coupling organ 116 can be pre-mounted on the first hammer 110.

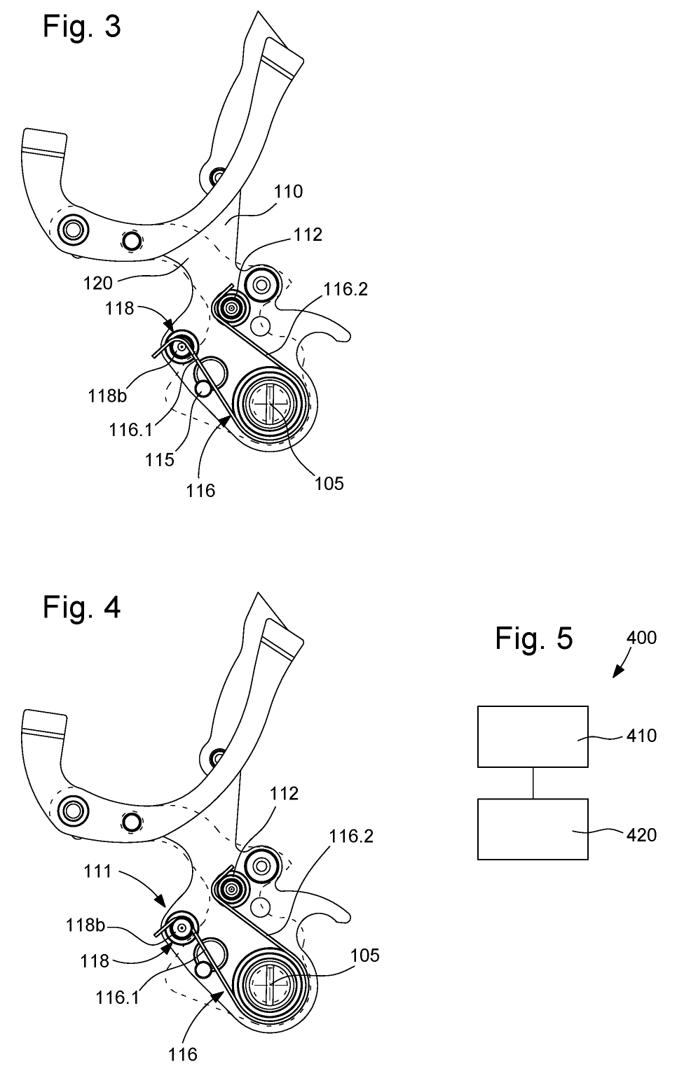

The preliminary support organ 115 acts to elastically restrain the resilient coupling organ 116 on the second hammer 120 in a position known as the pre-assembly position. This position is illustrated particularly clearly in FIGS. 2 and 3.

The preliminary support organ 115 is configured to support the first bracket 116.1 on the resilient coupling organ 116, such that the resilient coupling organ 116 can be elastically restrained in its pre-assembly position

between the preliminary support organ 115 and the second support organ 112 of the second hammer 120.

To pivot the resilient coupling organ 116 to its operating position when assembling the two hammers 110, 120 by relative axial displacement in a direction parallel to the axis of rotation 105, the zero reset mechanism 100 comprises a clip-on organ 118 secured to the hammer that does not comprise the preliminary support organ 115. In the exemplary embodiment shown, the clip-on organ 118 is arranged on the first hammer 110.

The clip-on organ 118 protrudes relative to the body of the first hammer 110 towards the second hammer 120. The clip-on organ 118 extends in a direction parallel to the axis of rotation 105 of the hammers 110, 120.

The clip-on organ 118 comprises a body 118a, a portion of which forms the first support organ 111 on the first hammer 110, and an end cone 118b, distal to the body of the first hammer, forming the free end of the clip-on organ 118.

The clip-on organ 118 is configured to come into contact with the first bracket 116.1 on the resilient coupling organ 116, via the end cone 118b, when the resilient coupling organ 116 is in the pre-assembly position on the second hammer 120. The end cone 118b enables the first bracket 116.1 to be engaged and its support to be changed by moving it onto the support organ 111 on the first hammer, by sliding the first bracket 116.1 on the conical surface of the end cone 118b. When sliding on the conical surface of the end cone 118b, the resilient coupling organ is slightly compressed.

Preferentially, the first support organ 111 comprises a recessed portion 117, for example a notch, a cavity, an indentation, an uneven surface configured to support the first bracket 116.1 on the resilient coupling organ 116 and to axially secure the resilient coupling organ 116, and more specifically the first bracket 116.1 on the resilient coupling organ 116, in an axial direction parallel to the axis of rotation 105 of the hammers 110, 120. This prevents axial sliding of the first bracket 116.1 on the resilient coupling

organ 116 and loss of support of the first bracket 116.1 on the first support organ 111 on the first hammer 110 when assembling the two hammers 110, 120.

The recessed portion 117 is formed near the base of the end cone 118b. In addition to axially securing the resilient coupling organ 116, the recessed portion 117 provides an audible and tactile indication to the horologist that the resilient coupling organ 116 is correctly positioned between the two hammers 110, 120 and accordingly the resilient coupling of the two hammers 110, 120.

According to a variant embodiment, a recessed portion, for example in the form of a notch, a cavity, an indentation or an uneven surface can be arranged on the second support organ 112 on the second hammer 120 to support the second bracket 116.2 on the resilient coupling organ 116 and to axially secure the resilient coupling organ 116.

Conventionally, the zero reset control 60 engages with a resilient zero reset element (not shown) configured to return the zero reset control 60 to a neutral locked position between each user actuation.

The zero reset mechanism 100 can also comprise a retaining organ (not shown) to secure the zero reset mechanism 100 and ensure that the zero reset control 60 is fully actuated. The retaining organ is configured to momentarily retain the actuation of the zero reset control 60 and thus of the hammers 11, 120, as long as a certain stress is not applied to the zero reset control 60. Such a retaining organ is a safety organ preventing an unintended zero reset of the hands of the chronograph mechanism 10. The retaining member exhibits dynamic behaviour similar to a mechanical fuse.

As shown in the various figures, the chronograph mechanism 10 comprises a column wheel 63 for controlling the various movements of various levers that bear on column or are between two columns. Since the operation of a chronograph mechanism 10 with such a column wheel 63 is widely known, it is not necessary to further explain the operation of such a wheel.

Of course, the chronograph mechanism 10 can also be a cam-mounted chronograph mechanism replacing the column wheel 63 without departing from the scope of the invention.

The invention also relates to a timepiece, for example a wristwatch, comprising such a horology movement.

The invention also relates to a method 400 for assembling the chronograph mechanism 10 according to the invention comprising the zero reset mechanism 100. More specifically, the assembly method according to the invention makes it easier to assemble and elastically couple the two hammers 110, 120.

With reference to FIG. 5, the method comprises a step 410 in which the resilient coupling organ 116 is pre-mounted, consisting of pre-positioning the resilient coupling organ 116 on one of the hammers, for example the second hammer 120, such that the resilient coupling organ 116 is kept in a pre-assembly position in a first compressed state between the preliminary support organ 115 carried by the second hammer 120 and the second support organ 112 on the second hammer 120. FIG. 3 particularly illustrates this first compressed state of the resilient coupling organ 116 in position on the second hammer 120.

Once the resilient coupling organ 116 has been pre-mounted on the second hammer 120, the method comprises a step 420 in which the two hammers 110, 120 are assembled by translation in a direction parallel to the axis of rotation 105.

The axial convergence of the two hammers 110, 120 allows the clip-on organ 118 to come into contact with the first bracket 116.1 on the resilient coupling organ 116 bearing on the preliminary support organ 115. With the axial displacement, the end cone 118b gradually compresses the resilient coupling organ 116 to release the pressure on the preliminary support organ 115. Once the first bracket 116.1 moves past the base of the end cone 118b, the first bracket 116.1 clips into the recessed portion 117 of the clip-on organ 118 by elastic return of the first bracket 116.1, as shown in FIG. 4. The resilient coupling organ 116 is then in its operating position, in a second compressed state, more compressed than the first compressed state of the pre-assembly position, and bearing on the first hammer 110 and the second hammer 120 to ensure rotationally elastic coupling between the two hammers 110, 120. In the operating position, the resilient coupling organ 116 is axially secured to prevent unintended contact loss.

1. A chronograph mechanism for a horology movement comprising a zero reset mechanism comprising:
a first hammer and a second hammer configured on two levels to respectively engage with a first zero reset organ on a first chronograph counter and a second zero reset organ on a second chronograph counter that are not coplanar; the first hammer and the second hammer pivoting separately relative to each other around at least one axis of rotation;
a resilient coupling organ, arranged between the first hammer and the second hammer, which has an operating position in which a first bracket bears on the first hammer and a second bracket bears on the second hammer;
wherein said zero reset mechanism comprises:
a preliminary support organ for the resilient coupling organ arranged on the second hammer and configured to support said first bracket on the resilient coupling organ in a pre-assembly position;
a clip-on organ, secured to the first hammer, configured to engage with the first bracket on the resilient coupling organ and move said resilient coupling organ into its operating position in which the first bracket bears on the clip-on organ to ensure rotationally elastic coupling of the first hammer and of the second hammer during a relative axial displacement between the first hammer and the second hammer in a direction parallel to the at least one axis of rotation, when the assembling the hammers.

2. The chronograph mechanism for a horology movement according to claim 1, wherein the resilient coupling organ ensures rotational coupling between the first hammer and the second hammer in the absence of a stress greater than a value predetermined by the stiffness of the resilient coupling organ applied to one of the hammers.

3. The chronograph mechanism for a horology movement according to claim 1, wherein the clip-on organ is configured to ensure a deflection of the resilient coupling organ when assembling the two hammers so that the resilient coupling organ, in the operating position, has a second compressed state that is more compressed than a first compressed state of the resilient coupling organ in the pre-assembly position on the second hammer.

4. The chronograph mechanism for a horology movement according to claim 1, wherein the clip-on organ extends in a direction parallel to said at least one axis of rotation of the hammers.

5. The chronograph mechanism for a horology movement according to claim 1, wherein the clip-on organ comprises a body with a portion forming a first support organ supporting the first bracket on the resilient coupling organ in the operating position of the resilient coupling organ and an end cone forming the free end of the clip-on organ.

6. The chronograph mechanism for a horology movement according to claim 5, wherein the first support organ on the first hammer has a recessed portion for axially securing the first bracket on the resilient coupling organ in an axial direction parallel to the at least one axis of rotation of the hammers.

7. The chronograph mechanism for a horology movement according to claim 6, wherein said recessed portion is formed near the base of the end cone.

8. The chronograph mechanism for a horology movement according to claim 1, wherein the second hammer comprises a second support organ configured to support the second bracket of the resilient coupling organ, the second support organ having a recessed portion for axially securing the second bracket on the resilient coupling organ in an axial direction parallel to the at least one axis of rotation of the hammers.

9. The chronograph mechanism for a horology movement according to claim 1, wherein the chronograph mechanism comprises a zero reset control that can be actuated by the user and configured to rotate the first hammer.

10. The chronograph mechanism for a horology movement according to claim 1, wherein the resilient coupling organ is shaped to elastically restrain the second hammer when it bears on a stop surface on the first hammer.

11. The chronograph mechanism for a horology movement according to claim 10, wherein the second hammer comprises a stop organ against which the support surface on the first hammer bears.

12. The chronograph mechanism for a horology movement according to claim 1, wherein the first hammer and the second hammer have a shared axis of rotation or have dedicated axes of rotation that are parallel to each other.

13. A horology movement comprising a chronograph mechanism according to claim 1.

14. A timepiece comprising a horology movement according to claim 13.

15. A method for assembling a chronograph mechanism comprising a zero reset mechanism comprising:
a first hammer and a second hammer pivoting around at least one axis of rotation and configured on two levels to respectively engage with a first zero reset organ on a first chronograph counter and a second zero reset organ on a second chronograph counter that are not coplanar;
a resilient coupling organ arranged between the first hammer and the second hammer and configured to rotationally couple the first hammer and the second hammer;
the method characterised in that it includes the following steps:
a step in which the resilient coupling organ is positioned on the second hammer, the resilient coupling organ being kept in a pre-assembly position in a first compressed state between a preliminary support organ carried by the second hammer and a second support organ on the second hammer;
a step in which the first hammer and the second hammer are assembled by relative axial displacement of the two hammers in a direction parallel to the at least one axis of rotation, the relative axial displacement between the two hammers ensuring elastic coupling between the two hammers.

16. The method for assembling a chronograph mechanism according to claim 15, wherein the elastic coupling between the two hammers in the assembly step is achieved by means of a clip-on organ secured to the first hammer and configured to engage with the resilient coupling organ in the pre-assembly position and to move said resilient coupling organ into an operating position, in a second compressed state, in which the resilient coupling organ is compressed between the clip-on organ and the second support organ on the second hammer.
